(19) United States
(12) Patent Application Publication
(10) Pub. No.: US 2004/0217977 A1
(43) Pub. Date: Nov. 4, 2004

(54) Display for measurement device

(75) Inventors: Masaharu Tomita, Mobara (JP); Takashi Muguruma, Mobara (JP); Yoshihisa Yonezawa, Mobara (JP); Katsumi Takayama, Mobara (JP); Hiroaki Kawasaki, Mobara (JP)

Correspondence Address: BACON & THOMAS, PLLC, 625 SLATERS LANE, FOURTH FLOOR, ALEXANDRIA, VA, 22314

(73) Assignee: FUTABA CORPORATION, Mobara (JP)

(21) Appl. No.: 10/834,052

(22) Filed: Apr. 29, 2004

(30) Foreign Application Priority Data
May 1, 2003 (JP) 2003-126099

(51) Int. Cl. G06T 11/20

(52) U.S. Cl. 345/619

(57) ABSTRACT

In a display for measurement devices for use in displaying a pointer image of a measurement, a movement of the pointer image is smooth and a visual perception of the pointer image is improved. As shown in FIG. 1A, a display segment group S formed of sub pointer image display segment columns is arranged along scales M in a semicircular shape (a fanwise shape). The pointer image P is made of four sub pointer image display segment columns Sx+1 to Sx+4. In case the pointer image P is moved from the position marked by the bold solid line to that represented by a bold dashed line, a new pointer image is made of sub pointer image display segment columns Sx+2 to Sx+5. In other words, the pointer image is moved in a unit of a sub pointer image display segment column.

### FIELD OF THE INVENTION

The present invention relates to a display for use in measurement devices; and more particularly, to a display capable of displaying smooth movement of a pointer image and providing high precision display of a measurement.

### BACKGROUND OF THE INVENTION

Referring to FIGS. 9A and 9B, there is illustrated a conventional display segment pattern of a display for use in measurement devices.

Recently, measurement devices employ a display for displaying a pointer image instead of an electrically or mechanically revolved or moved pointer.

FIG. 9A exemplifies a display segment pattern in which bar-shaped display segments are linearly arranged. A display segment group 2 made up of display segments 21 to 2n is arranged along scales 4 (see, for example, Japanese Patent Laid-open Publication No. 2000-79837). A display position of a pointer image on the display segments 21 to 2n is moved to the left or right according to a measurement. In FIG. 9A, a display segment 26 is lit, displaying the pointer image.

FIG. 9B shows a display segment pattern in which bar-shaped segments are arranged in a semicircular shape (a fan-shaped). A display segment group 3 including display segments 31 to 3n is arranged along scales 4 (see, for example, Japanese Patent Laid-open Publication No. 2000-136946). A display position of a pointer image of the display segments 31 to 3n is moved in a circumferential direction according to a measurement. As shown in FIG. 9B, a display segment 45 is lit, displaying the pointer image.

In case of FIG. 9A, if a measurement of the measurement device is changed, the pointer image is moved from the display segment 26 to the display segment 27 or 25. In such a case, the movement of the pointer image is not smooth in comparison with that of the electrically or mechanically operated conventional measurement device, which in turn leads to a poor visual perception. Also in the case of FIG. 9B, the movement of the pointer image is not smooth, similar to FIG. 9A, which leads to a same result of poor visual perception.

Moreover, in both cases of FIGS. 9A and 9B, a width of the display segments or an interval therebetween needs to be reduced in order to display the measurement with high precision, in which case with narrowing of the pointer image, the visual perception is deteriorated. Moreover, when the measurement device is applied to a speedometer of an automobile, for example, there is a great difficulty in reading the display position of the pointer image while driving with such poor visual perception.

### SUMMARY OF THE INVENTION

It is, therefore, an object of the present invention to provide a display for use measurement devices capable of smoothly moving a pointer image; improving a visual perception of a display position; and displaying a measurement with a high precision.

In accordance with a preferred embodiment of the present invention, there is provided a display for use in a measurement device including: a one or more row of parallelogrammic display segments (a1, b1, a2, b2 . . . ) in a serrated pattern arranged in a direction of movement of a pointer image; a row of parallelogrammic displays segments and pentagonal or hexagonal display segments (c1, d1, c2, d2 . . . ) in the serrated pattern arranged in the direction of movement of the pointer image; and a display segment group having a column (a1, b1, c1, d1) of the parallelogrammic display segments and the pentagonal or hexagonal display segments in the serrated pattern arranged in a direction substantially perpendicular to the direction of movement of the pointer image, wherein the pointer image is formed of a plurality of sub pointer image segment columns (a3, b2, c2, d1) including the parallelogrammic display segments (a3, b2, c2) arranged such that parallel sides of neighboring parallelogrammic display segments (a3, b2 and c2) are parallel; and the pentagonal or hexagonal display segment (d1) placed next thereto, and wherein the pointer image is moved per unit of the sub pointer image segment column.

In accordance with another preferred embodiment of the present invention, there is provided a display for use in a measurement device including: a one or more row of parallelogrammic display segments (c1, b1, c2, b2 . . . ) in a serrated pattern arranged in a direction of movement of a pointer image; a row of pentagonal or hexagonal display segments (d1, d2, d3 . . . ) in the serrated pattern arranged in the direction of movement of the pointer image; and a display segment group including a column of the parallelogrammic display segments (b1, c1, d1) and the pentagonal or hexagonal display segments in the serrated pattern arranged in a direction substantially perpendicular to the direction of movement of the pointer image, wherein the pointer image is formed of a plurality of sub pointer image segment columns (b2, c2, d1) including the parallelogrammic display segments (b2, c2) arranged such that parallel sides of neighboring parallelogrammmic display segments (b2, c2) are parallel; and the pentagonal or hexagonal display segment d1 placed next thereto, and wherein the pointer image is moved per unit of the sub pointer image segment column.

In accordance with still another preferred embodiment of the present invention, there is provided a display for use in a measurement device including: a display segment group having a row of display segments arranged in a direction of movement of a pointer image and a column of display segments arranged in a direction substantially perpendicular to the direction of movement of the pointer image, wherein the pointer image is formed by arranging a plurality of sub pointer image display segment columns made up of the display segments of the display segment group in the direction of movement of the pointer image, the pointer image being moved per unit of a sub pointer image display segment column.

### BRIEF DESCRIPTION OF THE DRAWINGS

The above and other objects and features of the present invention will become apparent from the following description of preferred embodiments given in conjunction with the accompanying drawings, in which:

FIGS. 1A and 1B describe a display segment pattern in which a display segment group is arranged in a semicircular shape (a fan shape) in accordance with a first preferred embodiment of the present invention;

FIGS. 2A and 2B illustrate a pointer image and a voltage applied to each electrode in accordance with a second preferred embodiment of the present invention;

FIGS. 3A and 3B explain a movement of the pointer image and a voltage applied to each electrode in accordance with the second preferred embodiment of the present invention;

FIGS. 4A and 4B show a pointer image and a voltage applied to each electrode when the arrangement of control electrodes differ from that in FIG. 2 in accordance with a fourth preferred embodiment of the present invention;

FIGS. 5A and 5B describe pointer images in accordance with a fifth preferred embodiment of the present invention;

FIGS. 6A and 6B illustrate a display segment pattern in which display segments are linearly arranged in accordance with a sixth preferred embodiment of the present invention;

FIGS. 7A and 7B show a display segment pattern in which bar-shaped display segments are linearly arranged in accordance with the sixth preferred embodiment of the present invention;

FIGS. 8A and 8B respectively set forth cross sectional views of fluorescent display tube forming a display for measurement devices in accordance with the present invention; and

FIGS. 9A and 9B describe conventional display segment patterns linearly arranged and in a semicircular shape, respectively.

### DETAILED DESCRIPTION OF THE PREFERRED EMBODIMENTS

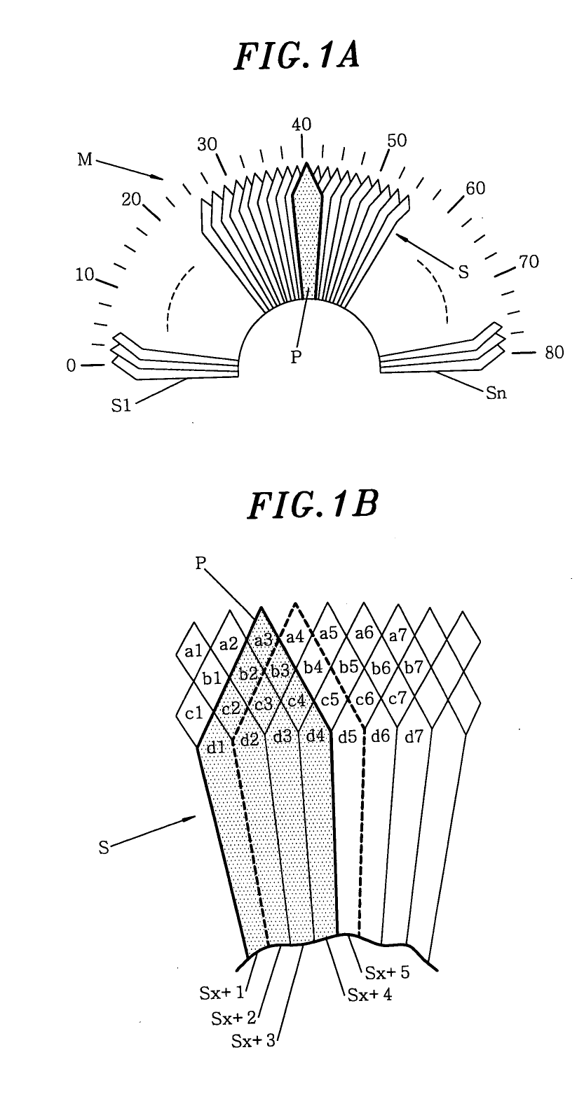

Display segment patterns of a display for measurement devices will be described hereinafter in accordance with preferred embodiments of the present invention with reference to FIGS. 1A to 8B, wherein like reference numerals represent like parts.

FIGS. 1A and 1B describe a display segment pattern in which display segments are arranged in a semicircular shape (i.e., a fan shape).

FIG. 1A illustrates the entire display segment pattern whereas FIG. 1B partially shows the pattern thereof.

As shown in FIG. 1A, a display segment group S is arranged along scales M disposed in the semicircular shape. A pointer image P is made up of a plurality of sub pointer images formed of sub pointer image display segment columns S1 to Sn. A display position of the pointer image P is circumferentially moved to the left or right according to a measurement. The movement of the pointer image P is conducted per unit of a sub pointer image, i.e., per unit of a sub pointer image display segment column.

The display segment group S includes a row of parallelogrammic display segments disposed in a direction of the movement of the pointer image P (in a circumferential direction) in a serrated pattern; and a row of parallelogrammic display segments and pentagonal display segments disposed in the direction of movement of the pointer image P in a serrated pattern. (The term serrated used herein refers to a chessboard pattern.) In other words, the display segment group S has a row of display segments a1, b1, a2, b2, a3, b3 . . . and a row of the display segments c1, d2, c2, d2, c3, d3 . . . , in serrated pattern. Further, in FIG. 1B, in the absence of the parallelogrammic display segments c1, c2, c3 . . . , a single row (in a non-serrated pattern) of the pentagonal display segments d1, d2, d3 . . . , may be formed instead.

Furthermore, the display segment group S has a plurality of columns respectively arranged in a serrated pattern in a direction substantially perpendicular to the direction of the movement of the pointer image P (i.e., in a radial direction). Specifically, the display segment group S includes the columns of the serrated pattern of the display segments (a1, b1, c1, d1), (a2, b2, c2, d2), . . . , (a7, b7, c7, d7), etc.

Among the rows in the serrated pattern, an arrangement of the display segments a1, a2, a3 . . . and b1, b2, b3 . . . alternately disposed in the serrated pattern is referred to as a row, for example. Also, among the columns in the serrated pattern, an arrangement of the display segments a1, b1, c1 and d1 alternately disposed in the serrated pattern is referred to as a column, for example.

Further, vertex of the parallelogrammic display segments and the pentagonal display segments face toward a direction substantially perpendicular to the direction of the movement of the pointer image P.

As shown in FIG. 1B, the pointer image P is formed of four sub pointer image display segment columns Sx+1 (a3, b2, c2, d1), Sx+2 (a4, b3, c3, d2), Sx+3 (a5, a4, c4, d3) and Sx+4 (a6, b5, c5, d4). Among the display segments of such four sub pointer image display segment columns, the segments (a3, b2, b3, c2, c3, c4, d1, d2, d3 and d4) surrounded by a bold solid line are lit as will be described later, thereby displaying the pointer image P. The sub pointer image display segment column Sx+1, for instance, is arranged so that respective two parallel sides of the parallelogrammic display segments a3, b2 and c2 are placed parallel; and is made up of the pentagonal display segment d1 placed next thereto.

The four sub pointer image segment columns Sx+1, Sx+2, Sx+3 and Sx+4 forming the pointer image P are arranged in a shape of an open parenthesis “<” and four of such columns are arranged in a direction of the width of the pointer image P (a direction of the movement of the pointer image P). The parallelogrammic display segments of each sub pointer image display segment column form a head portion of an arrow shape. (a triangular shape) of the pointer image P while the pentagonal display segments thereof form a main body portion of a quadrilateral (linear) shape of the pointer image P. Further, the sub pointer image display segment columns may be arranged in a shape of a reversed “<”.

In case the display portion of the pointer image P is moved to the right as a measurement of the measurement device is changed, the pointer image P is moved from the position marked by the bold solid line to that represented by a bold dashed line. Thus, a new pointer image made up of sub pointer image display segment columns Sx+2, Sx+3, Sx+4 and Sx+5 is obtained and display segments within the region surrounded by the bold dashed line are lit. Since the pointer image is moved per unit of a sub pointer image segment column, the movement of the pointer image is smooth which in turn better simulates a conventional pointer electrically or mechanically moved or revolved.

Since the pointer image P is made up of the four sub pointer image display segment columns Sx+1, Sx+2, Sx+3 and Sx+4 arranged in the width direction of the pointer image P (the direction of the movement of the pointer image P), the width of the pointer image P becomes four times that of a single sub pointer image display segment column. Thus, the display position of the pointer image P can be easily read even when the width of the sub pointer image display segment column is narrowed to enable display of high precision measurement. Further, since a vertex of the display segment a3 of the pointer image P points the scale M, it is possible to read the scale M with high precision even if the width of the pointer image P is enlarged as much as four times that of the sub pointer image display segment column.

Though FIG. 1 illustrates an example of arranging the display segments in the semicircular shape (the fan shape), they can also be linearly arranged, as will be described later.

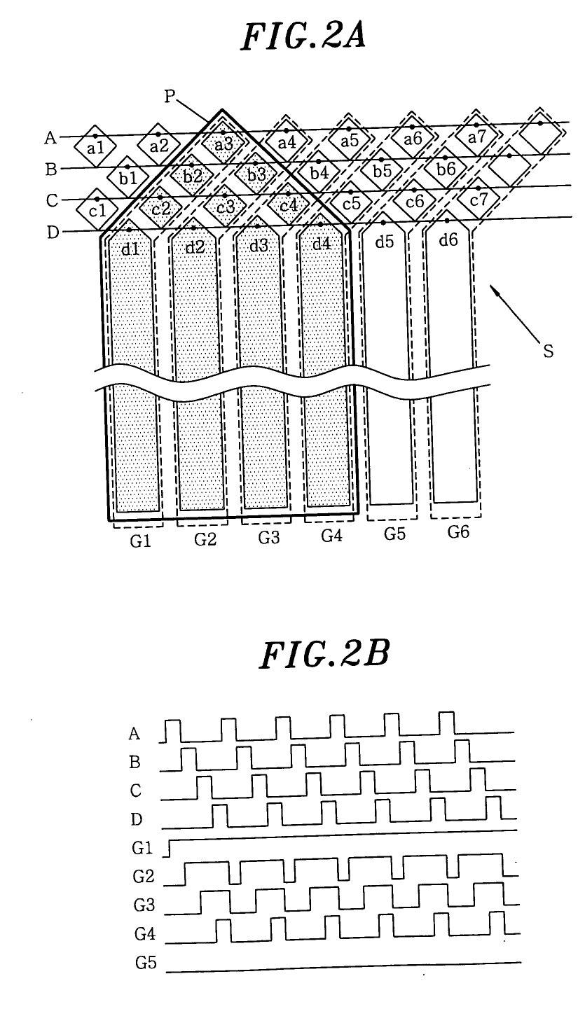

FIGS. 2A and 2B exemplarily describe voltages applied to display segment electrodes (anode electrodes) and control electrodes (grids) in case of displaying the pointer image P shown in FIGS. 1A and 1B by using fluorescent display tubes.

In particular, FIG. 2A illustrates an arrangement of the display segments and the control electrodes and FIG. 2B shows the application voltages.

Display segments a1 to a7, b1 to b6, c1 to c7 and d1 to d6 are formed of anode electrodes coated with fluorescent material, and emit light by electrons radiated from a cathode filament (not shown). The display segments a1 to a7, b1 to b6, c1 to c7 and d1 to d6 are connected through lines A to D, respectively, which are coupled to a power supply (not shown).

Control electrodes G1, G2, G3, and G4 (surrounded by dashed lines) are disposed corresponding to the display segments (a3, b2, c2, d1), (a4, b3, c3, d2), (a5, b4, c4, d3) and (a6, b5, c5, d4) which correspond to the sub pointer image display segment columns Sx+1, Sx+2, Sx+3 and Sx+4, respectively.

Referring to FIG. 2A, the display segments surrounded by a bold solid line are continuously lit, displaying a pointer image P, in which case the voltages descried in FIG. 2B are applied to the lines A to D and the control electrodes G1 to G5.

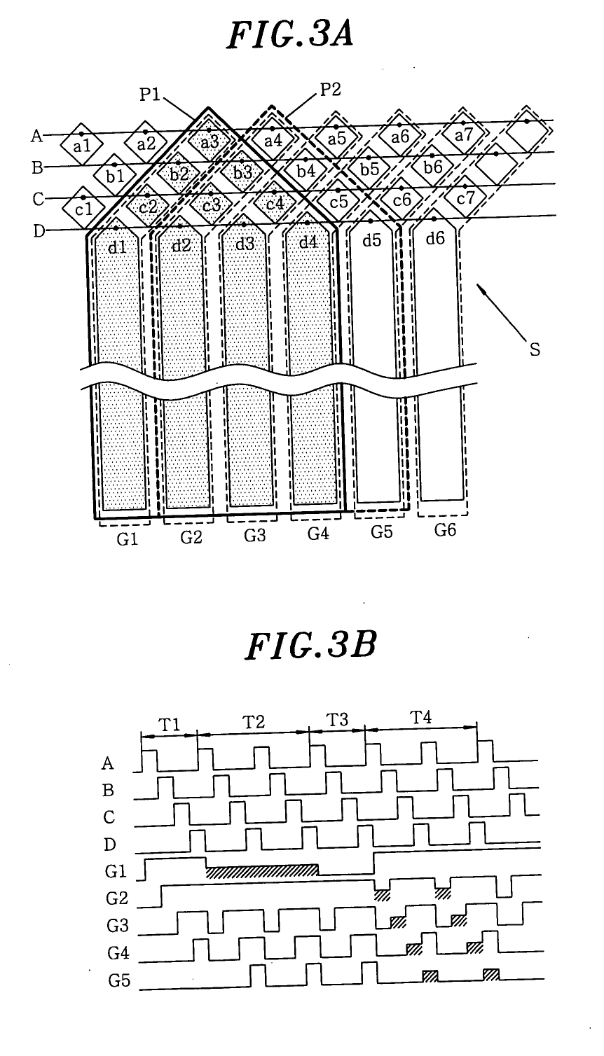

FIGS. 3A and 3B show a pointer image moving to the right or left under the same arrangement of display segments and control electrodes as those shown in FIG. 2A.

In particular, FIG. 3A show an example of displaying a pointer image P1 during a time period T1 shown in FIG. 3B; displaying a pointer image P2 during time periods T2 and T3; and displaying the pointer image P1 again during a time period T4.

During the time period T1, display segments surrounded by a bold solid line are lit, displaying the pointer image P1. Thereafter, display segments surrounded by a bold dashed line are lit during the time periods T2 and T3, displaying the pointer image P2.

At the time of changing the pointer image from P1 to P2, a voltage (shaded portion) lower than that employed in an ordinary lighting state is applied to a control electrode G1 disposed corresponding to the display segments a3, b2, c2 and d1 during the time period T2, to generate an afterimage thereon. Then, an off-voltage is applied to the control electrode G1 during the time period T3, to turn off the display segments a3, b2, c2 and d1. By generating such an afterimage, the movement of the pointer image can be displayed more smoothly.

When the pointer image is returned to the pointer image P1 from the pointer image P2, a lower voltage (shaded portion) is applied to control electrodes G2 to G5, to generate an afterimage on display segments a4, b4, c5 and d5.

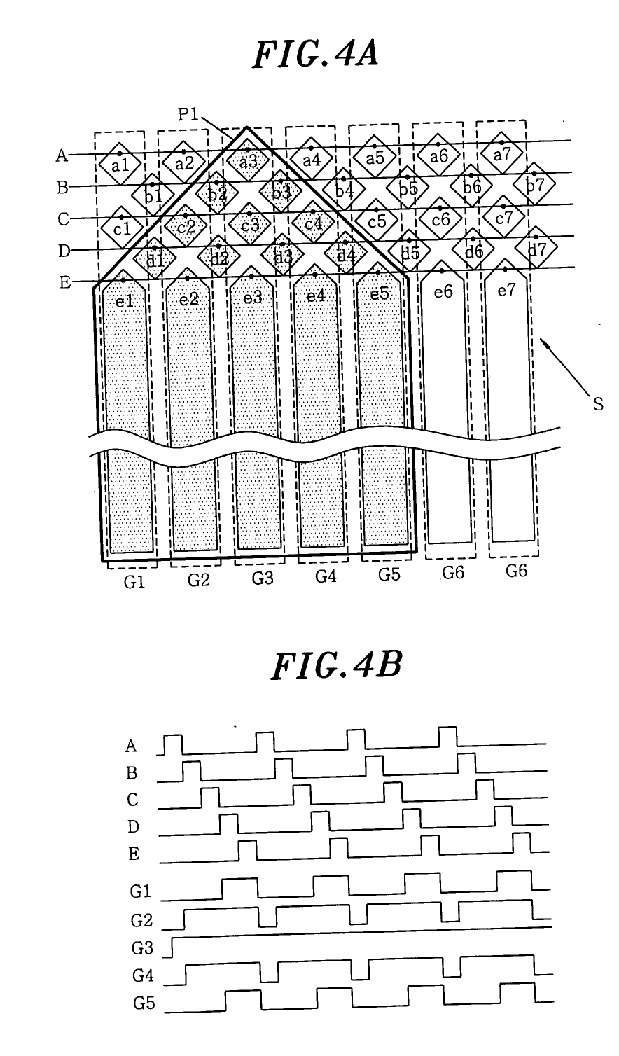

FIGS. 4A and 4B show an example where control electrodes are disposed in a direction substantially perpendicular to a direction of a movement of a pointer image P.

A basic configuration of a display segment group S is identical to that described in FIG. 1B with an exception of an additional row of parallelogrammic display segments in a serrated pattern provided in FIG. 4A.

The display segment group S includes rows of parallelogrammic display segments disposed in a serrated pattern in the direction of the movement of the pointer image (in a circumferential direction); and a row of pentagonal display segments disposed in the direction of the movement of the pointer image. In other words, the display segment group S has a row of the serrated patterned display segments a1, b1, a2, b2, a3, b3 . . . ; a row of the serrated pattern of display segments c1, d1, c2, d2, c3, d3 . . . ; and a row of pentagonal display segments e1, e2, e3, e4 . . . .

The pointer image P is made up of sub pointer image display segment columns (five columns) which are made up of display segments (a3, b2, c2, d1, e1), . . . , (a7, b6, c6, d5, e5), respectively.

Control electrodes G1 to G7 are arranged in the direction substantially perpendicular to the direction of the movement of the pointer image P. Display segments, e.g., b1 and d1, located at a boundary between two neighboring control electrodes, e.g., G1 and G2, emit light when both of the control electrodes G1 and G2 are on. Other segments emit light in the same manner described above.

In FIG. 4A, display segments surrounded by a bold solid line are continuously turned on, displaying the pointer image P, in which case voltages shown in FIG. 4B are applied to lines A to E and the control electrodes G1 to G5.

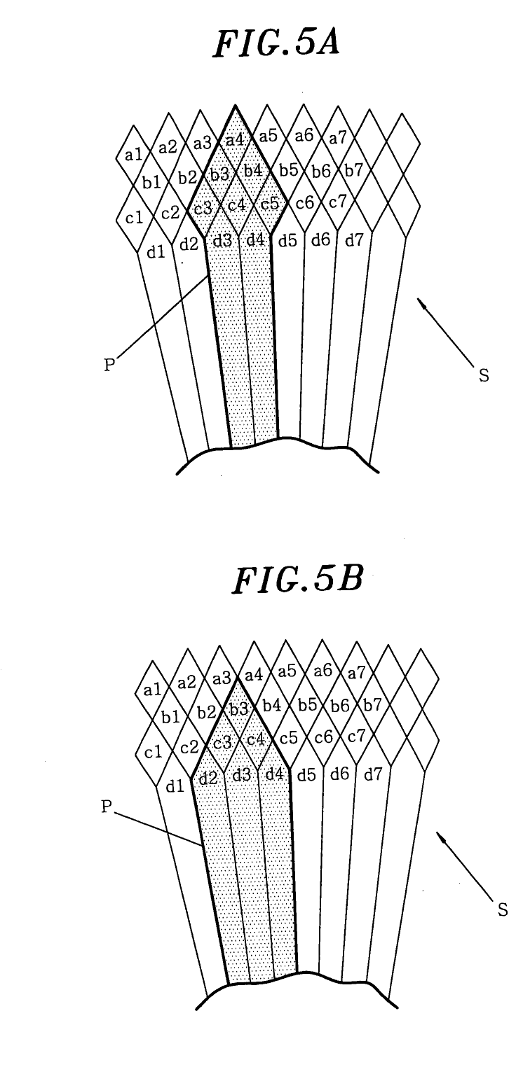

FIGS. 5A and 5B illustrate examples of using another pointer images having shapes different from those described in FIGS. 1A to 1B or FIG. 4A.

A configuration of display segment groups S in FIGS. 5A and 5B are identical to that described in FIG. 1.

FIG. 5A shows a pointer image P formed of three sub pointer image display segment columns, i.e., three sets of display segments (a4, b3, c3, d2), (a5, b4, c4, d3) and (a6, b5, c5, d4). In this case, the display segment d2 is not lit. The pointer image P in FIG. 5A has a head portion having a width greater than that of a main body portion thereof.

FIG. 5B provides an example of forming a pointer image P without using display segments a1 to a7. The pointer image P has a height (length) lower (shorter) than those of the pointer images shown in FIGS. 1A to 4B.

Further, a parallelogrammic display segment can be divided into two separate triangular display segments. In addition, each of pentagonal display segments d1 to d7 can be formed of one triangular display segment and one or more quadrilateral display segment. In such a case, in FIG. 5A, for example, it is possible to form the head portion of the pointer image P to have a triangular shape by lighting the triangular portions of the display segments d2 and d5.

Furthermore, the pentagonal display segments may be substituted with hexagonal display segments, in which case a hexagonal display segment can be divided into two separate pentagonal display segments, wherein the hexagonal display segment is formed of a pentagonal display segment and an inverted triangle at a bottom side thereof.

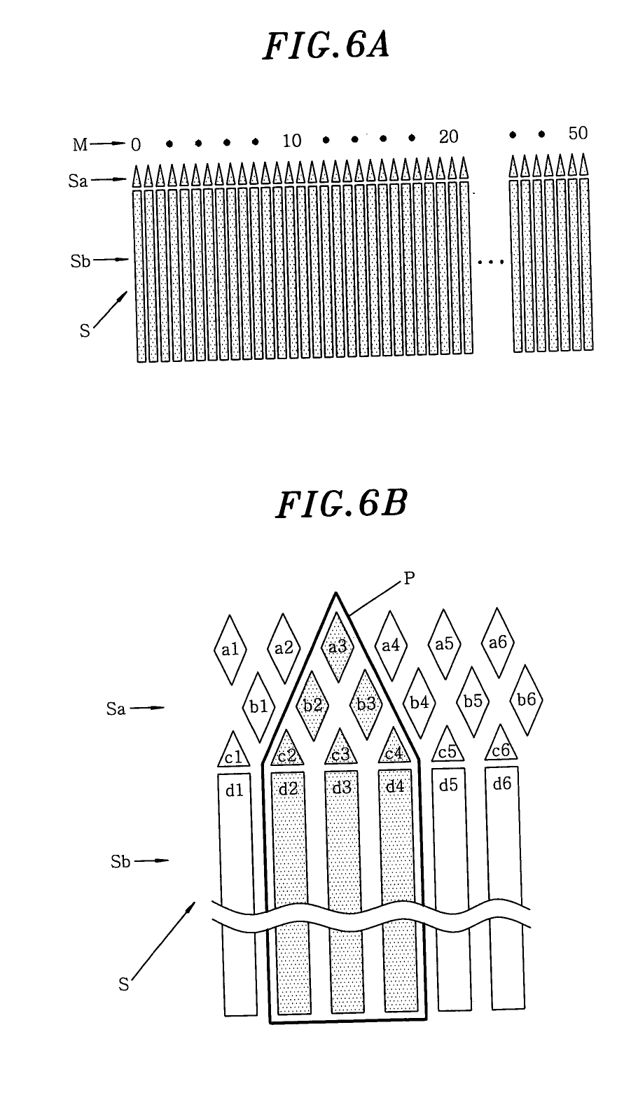

Referring to FIGS. 6A and 6B, there is described a display segment pattern where display segments are linearly arranged.

FIG. 6A shows the entire pattern while FIG. 6B illustrates partially the pattern thereof.

In FIG. 6A, a display segment group S is linearly arranged along scales M.

The display segment group S in FIG. 6A includes a display segment group Sa forming a head portion of a pointer image and a display segment group Sb forming a main body portion thereof. Details of the display segment groups Sa and the display segment Sb are described with FIG. 6B.

A basic configuration of the display segment group S shown in FIG. 6B is identical to that shown in FIG. 1B with an exception of the display segment group S in FIG. 6B including a single row of parallelogrammic display segments disposed in a serrated pattern and a single row of pentagonal display segments. The pentagonal display segments are divided into a triangular display segment and a quadrilateral display segment.

The display segment group Sa includes a row of parallelogrammic display segments a1, a2, a3 . . . and b1, b2, b3 . . . alternately disposed in a serrated pattern; and a row of triangular display segments c1, c2, c3 . . . , while the display segment group Sb includes a row of quadrilateral display segments d1, d2, d3 . . . .

A pointer image P is made up of sub pointer image display segment columns (a3, b2, c2, d2), (a4, b3, c3, d3) and (a5, b4, c4, d4). Among the display segments of those sub pointer image segment columns, display segments a3, b2, c2, d2, b3, c3, d3, c4, d4 surrounded by a bold solid line are lit, displaying the pointer image P. The pointer image P is moved per unit of a sub pointer image display segment column.

Further, the triangular display segments c1, c2, c3 . . . and the quadrilateral display segments d1, d2, d3 . . . can be integrated into pentagonal display segments without being divided.

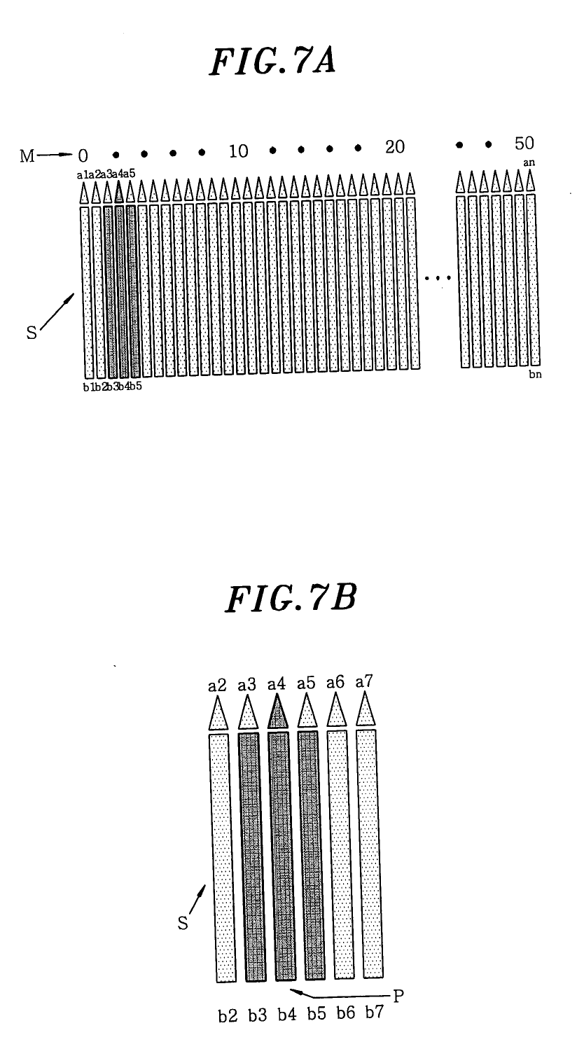

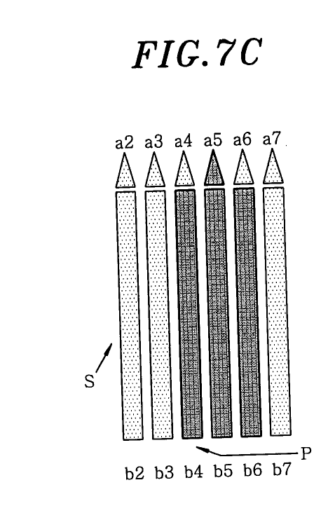

FIGS. 7A to 7C show a display segment pattern in which bar-shaped display segment patterns are linearly arranged.

FIG. 7A illustrates the entire pattern while FIGS. 7B and 7C partially show the pattern thereof.

As shown in FIG. 7A, a display segment group S including the bar-shaped display segments is linearly arrayed along scales M.

The display segment group S in FIG. 7A includes a row of triangular display segments a1 to an disposed in a direction of movement of a pointer image P; a row of rectangular display segments b1 to bn disposed in a direction of movement of a pointer image P; and a plurality of columns (a1, b1), (a2, b2), . . . , (an, bn) disposed in a direction substantially perpendicular to the direction of movement of the pointer image P. Vertex of the triangular display segments a1 to an point toward the scales M.

The pointer image P is formed of three sub pointer image display segment columns (a3, b3), (a4, b4) and (a5, b5) and one pointer image P is displayed by simultaneously lighting the display segments a4, b3, b4 and b5.

When the display position of the pointer image P is moved to the right from the position shown in FIG. 7B due to a change in a measurement of the measurement device, a new pointer image P made up of sub pointer image display segment columns (a4, b4), (a5, b5) and (a6, b6) as shown in FIG. 7C is displayed by simultaneously lighting the display segments a5, b4, b5 and b6, at which time an afterimage on the display segment b3 of the sub pointer image display column (a3, b3) is generated. Since the pointer image P is moved per unit of a sub pointer image display segment column, a smooth movement thereof can be observed.

Furthermore, the number of sub pointer image display segment columns forming the display segment P is not limited to three. In addition, the display segment group S can be formed only with the rectangular display segments b1 to bn while omitting the triangular display segments a1 to an. In such case, the rectangular display segments b1 to bn may be divided into a plurality of display segments.

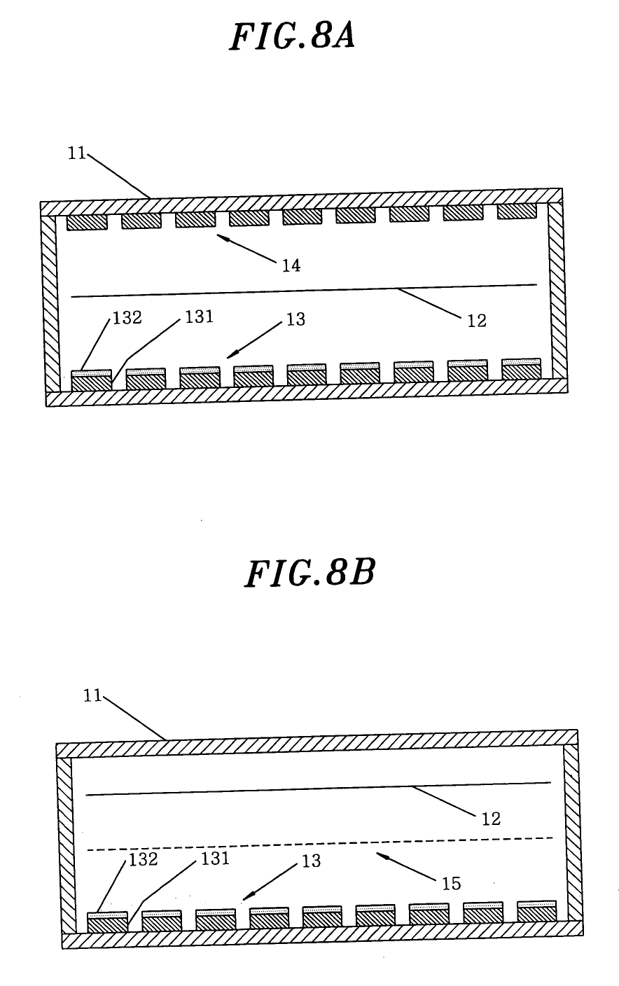

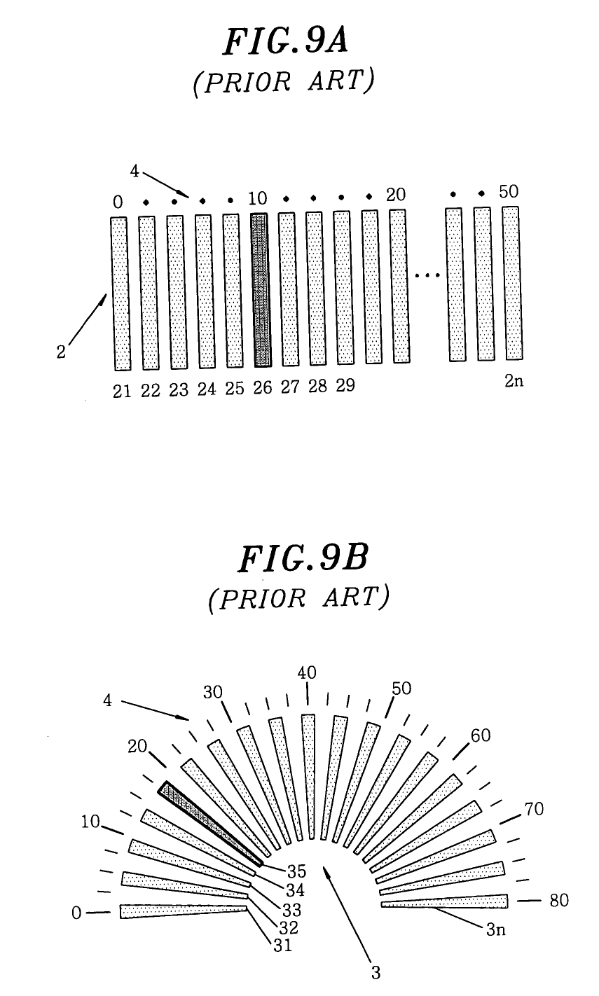

Referring to FIGS. 8A and 8B, there are provided cross sectional views of a fluorescent display tube for use in forming a display for measurement devices in accordance with the preferred embodiment of the present invention.

In FIG. 8A, an anode electrode group 13 serving as the display segments is formed at one side of facing substrates of a glass case 11 and a control electrode (rear grid) group 14 is formed at the other side. The anode electrode group. 13 includes a plurality of anode electrodes 131 coated with fluorescent material 132. Control electrode of the control electrode group 14 is formed of, e.g., a thin metal film. Disposed between the anode electrode group 13 and the control electrode group 14 is a filament 12 serving as a electron source.

Referring to FIG. 8B, a control electrode (e.g., mesh-shaped grid) group is installed between the anode electrode group 13 and the filament 12.

Although the preferred embodiment of the present invention describes a case where the present invention is applied to the fluorescent display tube, the present invention is not limited thereto. That is, the present invention can be applied to a display, e.g., a EL, a light emitting diode, a liquid crystal display or the like.

Also, display segment groups S may have one or more rows of parallelogrammic display segments arranged in a serrated pattern.

While the invention has been shown and described with respect to the preferred embodiment, it will be understood by those skilled in the art that various changes and modifications may be made without departing from the spirit and scope of the invention as defined in the following claims.

What is claimed is:

1. A display for use in a measurement device comprising:
a one or more row of parallelogrammic display segments (a1, b1, a2, b2 . . . ) in a serrated pattern arranged in a direction of movement of a pointer image;
a row of parallelogrammic displays segments and pentagonal or hexagonal display segments (c1, d1, c2, d2 . . . ) in the serrated pattern arranged in the direction of movement of the pointer image; and
a display segment group including a column (a1, b1, c1, d1) of the parallelogrammic display segments and the pentagonal or hexagonal display segments in the serrated pattern arranged in a direction substantially perpendicular to the direction of movement of the pointer image,
wherein the pointer image is formed of a plurality of sub pointer image segment columns (a3, b2, c2, d1) including the parallelogrammic display segments (a3, b2, c2) arranged such that parallel sides of neighboring parallelogrammic display segments (a3, b2 and c2) are parallel; and the pentagonal or hexagonal display segment (d1) placed next thereto, and wherein the pointer image is moved per unit of the sub pointer image segment column.

2. The display for use in a measurement device of claim 1, wherein the point image includes a head portion formed of the parallelogrammic display segments and a main body portion formed of the pentagonal or hexagonal display segment.

3. The display for use in a measurement device of claim 1; wherein each of the parallelogrammic display segments is formed of two separate triangular display segments.

4. The display for use in a measurement device of claim 1, wherein the pentagonal display segment is formed of a triangular display segment and a quadrilateral display segment, the hexagonal display segment being formed of two separate pentagonal display segments.

5. The display for use in a measurement device of claim 1, wherein an afterimage is generated when the pointer image is moved per unit of the sub pointer image display segment column.

6. A display for use in a measurement device comprising:
a one or more row of parallelogrammic display segments (c1, b1, c2, b2 . . . ) in a serrated pattern arranged in a direction of movement of a pointer image;
a row of pentagonal or hexagonal display segments (d1, d2, d3 . . . ) in the serrated pattern arranged in the direction of movement of the pointer image; and
a display segment group including a column of the parallelogrammic display segments (b1, c1, d1) and the pentagonal or hexagonal display segments in the serrated pattern arranged in a direction substantially perpendicular to the direction of movement of the pointer image,
wherein the pointer image is formed of a plurality of sub pointer image segment columns (b2, c2, d1) including the parallelogrammic display segments (b2, c2) arranged such that parallel sides of neighboring parallelogrammmic display segments (b2, c2) are parallel; and the pentagonal or hexagonal display segment d1 placed next thereto, and wherein the pointer image is moved per unit of the sub pointer image segment column.

7. The display for use in a measurement device of claim 6, wherein the point image includes a head portion formed of the parallelogrammic display segments and a main body portion formed of the pentagonal or hexagonal display segment.

8. The display for use in a measurement device of claim 6, wherein each of the parallelogrammic display segments is formed of two separate triangular display segments.

9. The display for use in a measurement device of claim 6, wherein the pentagonal display segment is formed of a triangular display segment and a quadrilateral display segment, the hexagonal display segment being formed of two separate pentagonal display segments.

10. A display for use in a measurement device comprising:
a display segment group including a row of display segments arranged in a direction of movement of a pointer image and a column of display segments arranged in a direction substantially perpendicular to the direction of movement of the pointer image,
wherein the pointer image is formed by arranging a plurality of sub pointer image display segment columns made up of the display segments of the display segment group in the direction of movement of the pointer image, the pointer image being moved per unit of a sub pointer image display segment column.

11. The display for use in a measurement device of claim 10, wherein an afterimage is generated when the pointer image is moved per unit of the sub pointer image display segment column.
